(19) United States
(12) Patent Application Publication
(10) Pub. No.: US 2024/0274347 A1
(43) Pub. Date: Aug. 15, 2024

(54) INDUCTOR AND METHOD FOR MANUFACTURING THE SAME

(71) Applicants: SHENZHEN POCO MAGNETIC CO., LTD., Shenzhen City (CN); HUIZHOU POCO INDUSTRY CO., LTD., Huizhou City (CN); HEYUAN POCO MAGNETIC CO., LTD., Heyuan City (CN)

(72) Inventors: ZHUOQUAN WU, Shenzhen City (CN); XIONGZHI GUO, Shenzhen City (CN); LINKAI MA, Shenzhen City (CN); YANG CHEN, Shenzhen City (CN); ZHIHANG JIANG, Shenzhen City (CN); BOHUI WANG, Shenzhen City (CN)

(21) Appl. No.: 18/437,828

(22) Filed: Feb. 9, 2024

(30) Foreign Application Priority Data
Feb. 9, 2023 (CN) 202320283658.2

(51) Int. Cl. H01F 27/29; H01F 17/04; H01F 41/02; H01F 41/10

(52) U.S. Cl. CPC H01F 27/292; H01F 17/04; H01F 41/0246; H01F 2017/048; H01F 41/10

(57) ABSTRACT

The present invention provides an inductor and method for manufacturing the same. The inductor comprises: a magnetic core; a conductive coil embedded in the magnetic core; and electrodes exposed outside a lead surface of the magnetic core; wherein the lead surface of the magnetic core has a pair of diagonal corners; a pair of leads of the conductive coil respectively extend from an inside of the magnetic core; and terminals of the leads respectively extend from the diagonal corners of the magnetic core, are curved and flattened on the lead surface of the magnetic core to form planar electrodes.

### CROSS REFERENCE TO RELATED APPLICATIONS

The present invention is 35 U.S.C. § 119 benefit of earlier filing dates; rights of priority of Chinese Applications No. 202320283658.2 filed on Feb. 9, 2023, the disclosure of which is incorporated by reference herein.

### BACKGROUND OF THE INVENTION

### Field of the Invention

The present invention relates to the field of electronic components, and more particularly, to an inductor and a method for manufacturing the same.

### Description of Related Art

Surface mount inductors, or SMD inductors, or molding inductors, or chip inductors, are generally designed as rectangular cubes; each comprise a rectangular magnetic core and a conductive coil, leads of the conductive coil extends outwards from both sides of the magnetic core. Curving the leads of the conductive coil occupies space, whereby a space for the conductive coils may be reduced, or a volume of the magnetic core may be reduced; or a wire diameter of the conductive coil may be reduced, no matter how to adjust, inductor performance degrades or inductor volume is wasted.

### BRIEF SUMMARY OF THE INVENTION

An object of the present invention is to is to provide an inductor to solve the problems of existing chip inductors that inductor performance degrades or inductor volume is wasted.

The present invention provides a chip inductor, comprising: a magnetic core; a conductive coil embedded in the magnetic core; and electrodes exposed outside a lead surface of the magnetic core; wherein the lead surface of the magnetic core has a pair of diagonal corners; a pair of leads of the conductive coil respectively extend from inside the magnetic core; and terminals of the leads respectively extend from the diagonal corners of the magnetic core, are curved and flattened on the lead surface of the magnetic core to form planar electrodes.

In some embodiments, the pair of diagonal corners has a longer or the longest diagonal line than other opposite corners of the lead surface of the magnetic core.

In some embodiments, lead slots are formed in a pair of diagonal edges of the magnetic core corresponding to the pair of diagonal corners thereof, each lead slot extends along a length of the diagonal edge, and is adapted for the lead of the conductive coil; the leads are inserted into the lead slots respectively; the lead surfaces of the magnetic core are formed with two concaves each at the diagonal corner respectively, and the terminals of the leads are pressed and laid flat in the grooves.

In some embodiments, the magnetic core is an insulating cylinder made of soft magnetic powder pressed in a mold; the conductive coil is embedded inside the magnetic core; there is a preset space between adjacent turns of the conductive coil, soft magnetic powder is filled into the preset space to form an insulating layer between adjacent turns; the leads of the conductive coil are bent from a medial portion of the conductive coil and inserted into the lead slots to extend toward the lead surface of the magnetic core.

In some embodiments, the surface of the magnetic core is covered with an insulating film layer; a metal coating layer is formed on the lead surface of the magnetic core through metallization treatment, and the metal coating layer covers on the terminals of the leads to form planar electrodes on the lead surface of the magnetic core, thereby forming extended planar electrodes.

In some embodiments, metal coating layers each with a preset width are formed along corresponding edges connected to the diagonal corners respectively, thereby forming a pair of parallel planar electrodes.

A method for manufacturing an inductor, comprises steps of:
step 201, fitting a conductive coil onto a lower mold of a mold for performing primary pressing, where a pair of leads of the conductive coil respectively extending along a pair of diagonal edges of the lower mold;
step 202, filling soft magnetic powder into a mold cavity in the mold and performing primary pressing to obtain a product comprising a magnetic core with the conductive coil embedded therein, and a pair of leads of the conductive coil respectively extending from inside the magnetic core; and terminals of the leads respectively extend from a pair of diagonal corners of the magnetic core;
step 203, performing secondary pressing to the product of step 202 to bend and press the terminals of the leads onto a lead surface of the magnetic core;
step 204, annealing;
step 205, spraying insulating film on surfaces of the magnetic core; and
step 206, performing metallization treatment to form metal coating covering the terminals so as to form planar electrodes exposed outside the lead surface.

The inductor and the method for manufacturing the same of the present invention obtain advantages as follows:
the leads of the conductive coil extend outward along a diagonal of the magnetic core, according to a principle of the longest diagonal line, the magnetic core can provide more space for extending and curving the leads of the conductive coil, while not reduce the space of the magnetic core or the space of conductive coil or the wire diameter of the conductive coil, thereby the electromagnetic performance and space utilization of the inductor is improved.

In other embodiments, the lead surface of the magnetic core is cut out into a triangular shape, and after secondary pressing, exposed portions of the leads form electrodes of the inductor, which can reduce the inductor size.

After high-temperature annealing treatment, stress in the magnetic core can be well reduced, and an inductor with high inductance value and low loss can be obtained.

### BRIEF DESCRIPTION OF THE DRAWINGS

FIG. 1 illustrates a plan view of an inductor in accordance with an embodiment of the present invention;

FIG. 2 illustrates a perspective view of the inductor in accordance with the embodiment of the present invention;

FIG. 3 illustrates a transparent view of the inductor before secondary pressing in accordance with an embodiment of the present invention;

FIGS. 4-5 illustrate transparent views of the inductor after secondary pressing in accordance with an embodiment of the present invention;

FIG. 6 illustrates a diagram of the production line for manufacturing the inductor of the present invention;

FIG. 7 illustrates a step of manufacturing the inductor at which the conductive coil is installed onto a lower mold;

FIGS. 8(a) and 8(b) illustrates the mold and the production at a step of performing a primary pressing, where FIG. 8(a) illustrates a mold structure, and FIG. 8(b) illustrates the product; and

FIG. 9 illustrates a step of performing a secondary pressing step of manufacturing the inductor.

### DETAILED DESCRIPTION OF THE INVENTION

An inductor and a method for manufacturing the same are described herein.

Certain terminology is used in the following description for convenience only and is not limiting. The words “right,” “left,” “top,” and “bottom” designate directions in the drawings to which reference is made. The words “a” and “one,” as used in the claims and in the corresponding portions of the specification, are defined as including one or more of the referenced item unless specifically stated otherwise. This terminology includes the words above specifically mentioned, derivatives thereof, and words of similar import. The phrase “at least one” followed by a list of two or more items, such as “A, B, or C,” means any individual one of A, B or C as well as any combination thereof. It may be noted that some Figures are shown with partial transparency for the purpose of explanation, illustration and demonstration purposes only, and is not intended to indicate that an element itself would be transparent in its final manufactured form.

The description provided herein is to enable those skilled in the art to make and use the described embodiments set forth. Various modifications, equivalents, variations, combinations, and alternatives, however, will remain readily apparent to those skilled in the art. Any and all such modifications, variations, equivalents, combinations, and alternatives are intended to fall within the spirit and scope of the present invention defined by claims.

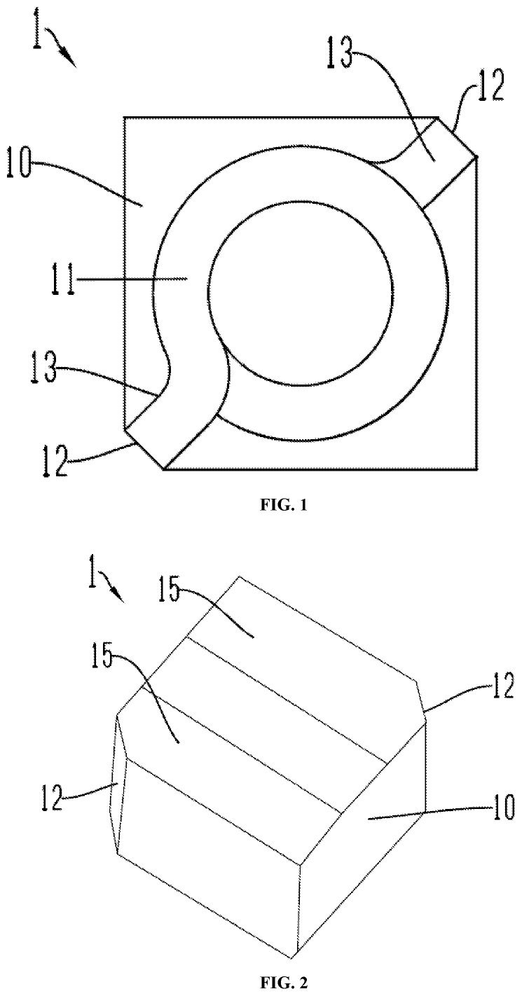

Referring to FIGS. 1-5, the inductor 1 of the present invention, may be a surface mount inductor, or SMD inductor, or molding inductor, or chip inductor, includes a magnetic core 10 and a conductive coil 11 inside the magnetic core 10; opposite ends of the conductive coil 11 forms two leads 13, a terminal 15 of each lead 13 is preferably exposed outside of the magnetic core 10.

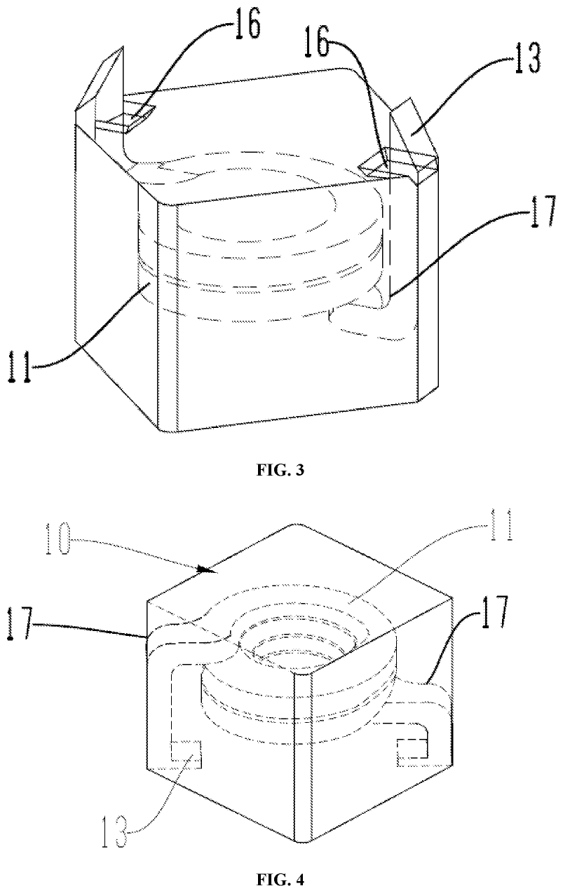

In an embodiment, the conductive coil 11 is positioned in a metal mold, the granulated powder (soft magnetic metal powder) is poured into a cavity of the metal mold, and the granulated powder and the conductive coil 11 are then press-molded together at a molding pressure of 5 to 16 ton/cm² to be cured to manufacture a molded body. The molded body was heat-treated, so that an inductor 1 of example, in which the conductive coil 11 is embedded in a magnetic core 10, was manufactured. The magnetic core 10 is an insulating cylinder made of granulated powder (soft magnetic metal powder). The cylindrical magnetic core 10 of example has a cross-sectional shape of a square or other shape and has a pair of cutout diagonal corners 12, and a lead slot 17 with a predetermined height is formed inside the magnetic core corresponding to the diagonal corners 12 along a height direction of the magnetic core 10 (as shown in FIGS. 3-5). A lead surface of the magnetic cores 10 forms one concave 16 at each cutout diagonal corner 12, and the concaves 16 communicated with the corresponding lead slot 17 at each cutout diagonal corner 12. The lead slot 17 is adapted to the lead 13 of the conductive coil 11, and the concave 16 is adapted to the terminal of the lead 13. Terminals 15 lie flat in recesses 16 formed at opposite corners 12 of the lead surface of the magnetic core 10. The opposite corners 12 along the height of the magnetic core 10 is cut out. Preferably, the cross-section of the diagonal 12 has a longer or longest diagonal line which is longer than the side length. The lead slots 17 are formed inside the magnetic core 10, and concaves 16 are formed in the lead surface (or an end surface) of the magnetic core 10.

The magnetic core 10 of example is a square cylinder, and two lead slots 17 of a predetermined height are formed inside the diagonal corners 12 of the square cylinder along a height direction of the magnetic core 10. The diagonal corners 12 of the square cylinder are cutout extending from a top to a bottom end surfaces of the magnetic core 10. One concave 16 formed at each of the diagonal corners 12 on the top surface of the square magnetic core 10, which is connected with the corresponding lead slot 17 and is used to accommodate the terminal 15 of the lead 13.

The conductive coil 11 is embedded inside the magnetic core 10. The conductive coil 11 can be wound with any number of turns as required using metal wires such as copper wires or silver wires. Adjacent turns of the conductive coil 11 has a preset distance d therebetween, and is filled with soft magnetic powders to form an insulating layer therebetween when press-mold to separate adjacent turns of the conductive coils. The leads 13 of the conductive coil 11 are bent from the conductive coil, for example, bending 90 degrees. After the leads 13 are bent from the conductive coil, they are inserted into the lead slots 17 and extend toward the end surface (top surface or lead surface) of the magnetic core 10. The opposite terminals 15 of the two leads 13 are respectively flattened in the diagonal concaves 16 at lead surface of the magnetic core and keep the lead surface flat.

Surface of the magnetic core 10 is covered with an insulating film layer for anti-corrosion and anti-rust. One end surface (that's the lead surface) of the magnetic core 10 is coated with a metal coating layer for coving each terminal 15 of the lead 13 in the concave 16 or expanding an area or a length of the terminal 15 so as to form an extended planar terminal 15 along opposite sides of the end surface, which can save a mounting space for the inductor on a PCB.

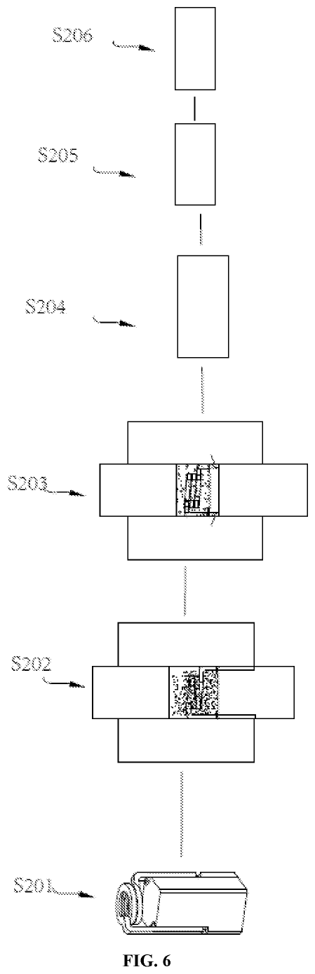

Referring to FIG. 6, a production line for illustrate steps of a method for manufacturing an inductor in accordance with an embodiment of the present invention, comprising steps of:
step 201, fitting a conductive coil in a mold;
step 202, performing primary pressing;
step 203, performing secondary pressing;
step 204, annealing;
step 205, spraying insulating film; and
step 206, performing metallization treatment.

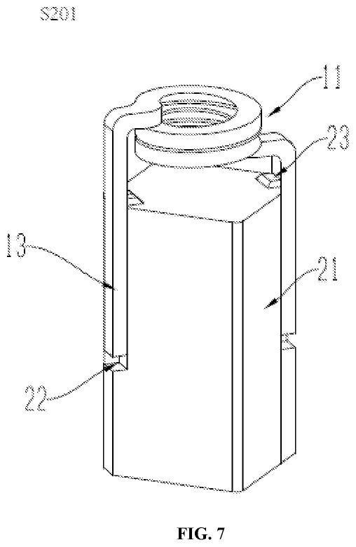

At the step 201, referring to FIGS. 6-7, fit the conductive coil 11 to a lower mold of the mold for performing primary pressing. Where the lower mold 21 of example is a square cylinder, a pair of diagonal edges thereof are cut out and each forms a longitudinal slot 22 with a preset length extending along the corresponding cutout diagonal edge. The slot 22 is adapted to the lead 13 of the conductive coil 11, and each lead 13 of the conductive coil 11 is inserted into each slot 22. A raised platform 23 is formed at each diagonal corner at the top surface of the lower mold 21 according to the cutout diagonal edges, so that the concaves 16 will be formed on the top surface (lead surface) of the magnetic core 10 after pressing powdered magnetic materials. The conductive coil is a primary winding coil which is made of copper, silver or other metals, and the number of turns can be arbitrary as needed. The two leads 13 of the conductive coil are bent at 90° (not limited to 90°) from a medial portion of the conductive coil. Adjacent turns of the conductive coil 11 has a preset distance d therebetween, and is filled with soft magnetic powders to form an insulating layer therebetween when press-mold to separate adjacent turns of the conductive coils. The conductive coil 11 is installed to the lower mold 21, two leads 13 of the conductive coil 11 are inserted into the slots 22 respectively to support the medial portion of the conductive coil 11 above the top of the lower mold 22 to a predetermined height.

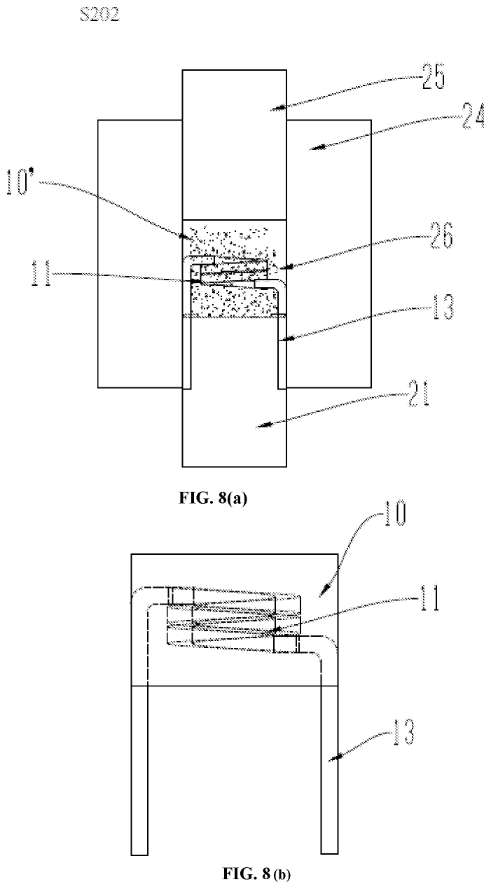

At the step 202, referring to FIG. 8(a), an upper mold 25, a middle mold 24 and the lower mold 21 are assembled into the complete mold for performing primary pressing; and a mold cavity 26 is formed in the complete mold. At the previous step 201, the conductive coil 11 is fitted on the lower mold 21, at this step, the middle mold 24 is installed on the lower mold 21 with the mold cavity 26 formed therebetween, and the conductive coil 11 is installed in a center of the mold cavity 26. Fill soft magnetic powder 10′ (such as FeSi, or FeSiAl, or FeNi, or pure Fe powder, or amorphous & nanocrystalline soft magnetic powder or any combinations thereof) into the mold cavity 26 so that the soft magnetic powder surround at least the medial portion of the conductive coil 11 and not surround the ends of the leads 13. Install the upper mold 25, and then perform primary pressing at a molding pressure of 12˜16 T/cm2. The soft magnetic powder can be powdered or granular magnetic particles, or more particularly, one or more of FeSi, or FeSiAl, or FeNi, or pure Fe powder, or amorphous & nanocrystalline particles, etc., and surfaces of the particles is coated with inorganic materials (such as silicon oxide, oxide Aluminum, etc.) to obtain soft magnetic particles with insulating performance. After removing the mold, the product is obtained after primary pressing as shown in FIG. 8(b), the magnetic core 10 with the conductive coil 11 embedded therein is obtained by press-mold, a pair of diagonal edges of the magnetic core 10 is longitudinally cutout according to the cutout diagonal edges of the lower mold 21, so as to form a pair of diagonal cutout edges 12 of the magnetic core 10. An end surface (lead surface or top surface) of the magnetic cores 10 forms two concave 16 at the cutout diagonal corners corresponding to the raised platforms 23 of the lower mold 21, and the concave 16 is communicated with the corresponding lead slot 17 at each cutout diagonal corner. The lead slot 17 is adapted to the lead 13 of the conductive coil 11, and the concave 16 is adapted to the terminal of the lead 13. Terminals 15 lie flat in the concave 16 and exposed outside the end surface (lead surface) of the magnetic core 10. The cutout diagonal edge 12 of the magnetic core 10 is cut out. Preferably, the cutout diagonal edges 12 or the cutout diagonal corners of the cross-section of the magnetic core have a longer or longest diagonal line therebetween than other diagonal edges. The lead slots 17 are formed inside the magnetic core 10, and concaves 16 are formed in the lead surface (or an end/top surface) of the magnetic core 10. The two leads 13 of the conductive coil 11 pass through the lead slots 17 respectively, and has opposite ends thereof extending outward from the cutout diagonal corners of the lead surface (or an end/top surface) of the magnetic core.

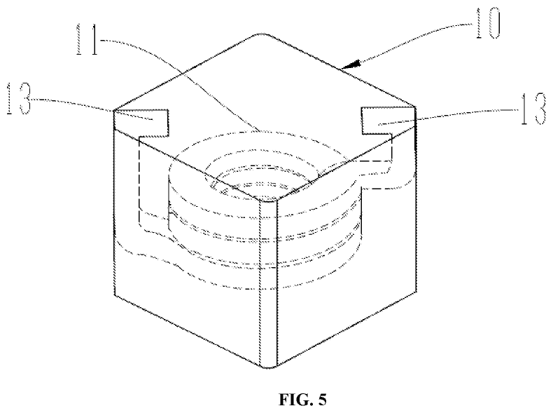

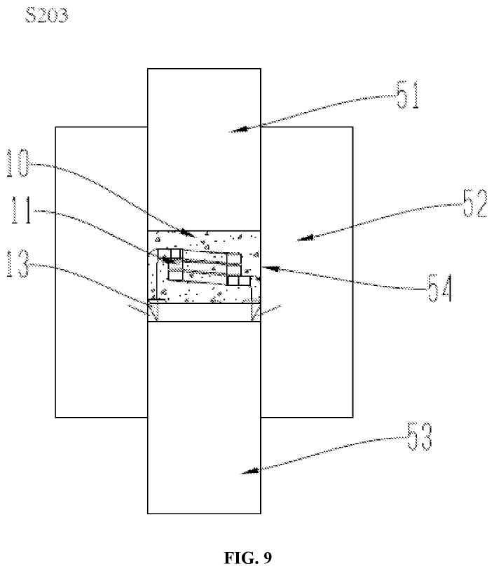

At step 203, referring to FIG. 9, a mold for performing secondary pressing includes an upper mold 51, a middle mold 52 and a lower mold 53, with a mold cavity 54 inside. cut the ends of the leads 13 that protrude from the top surface of the magnetic core into triangles (as shown in FIG. 3), and perform a secondary mold-pressing, that's, bend the triangular ends into the concave 16 in the top surface of the magnetic core 10 to form electrodes of the inductor. Additionally, to further reduce the size of the inductor, an excess length of the leads 13 may be cut off by laser cutting, shearing, or die punching, etc. Put the product into the mold cavity 54 for secondary pressing at a pressure of 16-24 T/cm2. Make the triangular ends of leads 13 bending during pressing and flatten into the concaves 16 respectively on the top surface of the magnetic core. The lead 13 (the conductive coil) is made of relatively soft metal, the end of lead 13 is cut into a tapered end, thereby the end of the lead 13 is easily curved and deformed under a pressure and form a planar terminal adapted to the concaves 16, as shown in FIGS. 4-5.

At the step 204, the product after secondary pressing is subjected to high-temperature annealing treatment in a high-temperature furnace, the annealing temperature may be 300 to 900° C., the annealing time may be 30 to 120 minutes, and annealing is carried out in nitrogen. After annealing, the internal stress in the magnetic core of the inductor can be fully removed or greatly reduced, which can improve the performance of the inductor.

At the step 205, a spraying equipment of the prior art can be used for spraying insulating film. The surface of the inductor after annealing is coated with an insulating film by spraying treatment. The spraying material can be epoxy resin, polyurethane resin, etc., so that the surface of the inductor can be evenly covered with a layer of organic insulation for anti-corrosion and anti-rust.

At the step 206, a metallization process of the prior art can be used for performing metallization treatment, such as an electroplating equipment or a vacuum coating equipment. Remove the coating on the terminals to expose the terminals of the leads 13, and then perform metallization treatment on the exposed parts, such as perform electroplating, vacuum plating One or more metals such as Cn, Ni, Ag, Sn, etc., therefore, metallic areas cover the terminals 15 in the concave 16 to an expanded electrode can be obtained. As an example, metallization is performed on the end surface (top surface/lead surface) of the magnetic core along both diagonal edges to form two spaced metal coating as spaced electrodes. thereby, the expanded terminals 15 or electrodes extend to both sides of the end surface of the magnetic core are formed, as shown in FIG. 2.

The inductor of the present invention can adopt a larger coil diameter to increase performances, which have higher product performances, and better magnetic core utilization.

The terminals 15 and the lead 13 of the conductive coil 11 of the present invention are arranged according to the longer or longest diagonal line of the magnetic core 10, which increases the application space of the magnetic core and improves the magnetic performance and electrical performance of the inductor. In the same installation space, the inductor of the present invention can use thicker wires, which allows greater current to pass through, thereby increases inductor power, and fully utilize magnetic core to improve magnetic performances.

The method of the present invention can make terminals 15 of the lead 13 into planar electrodes by secondary pressing, thereby obtain a patch inductor and save the mounting space of the inductor onto the PCB. Through high-temperature annealing in a protective atmosphere, the stress in the product is eliminated, which fully improve the magnetic performance of the product, and greatly improves the product performance.

The technical features of the above embodiments can be combined arbitrarily. In order to make the description simple, all possible combinations of the technical features in the above embodiments are not described. However, as long as there is no contradiction in the combination of these technical features It is considered to be the range described in this specification.

The above examples only represent several embodiments of the present invention, and the descriptions thereof are specific and detailed, but should not be construed as a limitation on the scope of the invention patent. It should be pointed out that for those of ordinary skill in the art, without departing from the concept of the present invention, several modifications and improvements can also be made, which all belong to the protection scope of the present invention. Therefore, the protection scope of the patent of the present invention should be subject to the appended claims.

1: An inductor, comprising:
a magnetic core;
a conductive coil embedded in the magnetic core; and
electrodes exposed outside a lead surface of the magnetic core;
wherein the lead surface of the magnetic core has a pair of diagonal corners; a pair of leads of the conductive coil respectively extend from an inside of the magnetic core; and terminals of the leads respectively extend from the diagonal corners of the magnetic core, are curved and flattened on the lead surface of the magnetic core to form planar electrodes.

2: The inductor as claimed in claim 1, wherein the pair of diagonal corners has a longer or the longest diagonal line than other opposite corners of the lead surface of the magnetic core; and the pair of diagonal corners are cut out to obtain a pair of cutout diagonal corners.

3: The inductor as claimed in claim 1, wherein lead slots are formed in a pair of diagonal edges of the magnetic core corresponding to the pair of diagonal corners thereof, each lead slot extends along a length of the diagonal edge, and is adapted for the lead of the conductive coil; the leads are inserted into the lead slots respectively; the lead surface of the magnetic core is formed with two concaves at the diagonal corners respectively, and the terminals of the leads are pressed and laid flat in the concaves; the pair of diagonal edges is cut out to obtain a pair of cutout diagonal edges.

4: The inductor as claimed in claim 3, wherein the magnetic core is an insulating cylinder made of soft magnetic powder pressed in a mold; there is a gap between adjacent turns of the conductive coil, soft magnetic powder is filled into the gap to form an insulating layer between adjacent turns; the leads of the conductive coil are bent from a medial portion of the conductive coil and extend in the lead slots toward the lead surface of the magnetic core.

5: The inductor as claimed in claim 1, wherein surfaces of the magnetic core are covered with an insulating layer; metal coatings are formed on the lead surface of the magnetic core through metallization treatment, and the metal coatings respectively cover the terminals of the leads to form planar electrodes on the lead surface of the magnetic core, thereby forming extended planar electrodes.

6: The inductor as claimed in claim 5, wherein metal coating layers each with a preset width are formed along corresponding edges connected to the diagonal corners respectively, thereby forming a pair of parallel planar electrodes.

7: A method for manufacturing an inductor, comprising steps of:
step 201, fitting a conductive coil onto a lower mold of a mold for performing primary pressing, wherein where a pair of leads of the conductive coil respectively extend along a pair of diagonal edges of the lower mold;
step 202, filling soft magnetic powder into a mold cavity in the mold and performing primary pressing to obtain a product comprising a magnetic core with the conductive coil embedded therein, the pair of leads of the conductive coil respectively extending from an inside of the magnetic core; and terminals of the leads respectively extend from a pair of diagonal corners of the magnetic core;
step 203, performing secondary pressing to the product of step 202 to bend and press the terminals of the leads onto a lead surface of the magnetic core;
step 204, annealing;
step 205, spraying insulating film on surfaces of the magnetic core; and
step 206, performing metallization treatment to form metal coating covering the terminals so as to obtain the inductor with planar electrodes exposed outside the lead surface.

8: The method as claimed in claim 7, wherein the pair of diagonal corners of a cross-section of the magnetic core have a longer or the longest diagonal line therebetween than other opposite corners of the magnetic core.

9: The method as claimed in claim 7, wherein at the step 201, the pair of diagonal edges of the lower mold are cut and each forms a longitudinal slot with a preset length extending along the corresponding diagonal edge; the slot is adapted to the lead of the conductive coil, each lead of the conductive coil is inserted into each slot.

10: The method as claimed in claim 7, wherein raised platforms are formed respectively at diagonal corners of a top surface of the lower mold according to the diagonal edges, whereby concaves will be formed on the lead surface of the magnetic core after primary pressing.

11: The method as claimed in claim 7, wherein the pair of leads of the conductive coil are bent from a medial portion of the conductive coil; adjacent turns of the conductive coil have a gap therebetween, and is filled with soft magnetic powder to form an insulating layer therebetween.

12: The method as claimed in claim 7, wherein the conductive coil is installed to the lower mold, the pair of leads of the conductive coil support a medial portion of the conductive coil above a top surface of the lower mold to a preset height.

13: The method as claimed in claim 7, wherein at the step 202, an upper mold, a middle mold and the lower mold are assembled into a complete mold for performing primary pressing; a mold cavity is formed in the complete mold; the conductive coil is installed in the mold cavity; the soft magnetic powder surrounds at least a medial portion of the conductive coil; perform primary pressing at a molding pressure of 12˜16 T/cm².

14: The method as claimed in claim 9, wherein at the step 202, a pair of diagonal edges corresponding to the pair of diagonal corners of the magnetic core are longitudinally cut edges according to the pair of diagonal edges of the lower mold.

15: The method as claimed in claim 10, wherein at the step 202, the lead surface of the magnetic core forms two concaves at the pair of diagonal corners corresponding to the raised platforms of the lower mold, and the concave is communicated with the corresponding lead slot at each diagonal corner.

16: The method as claimed in claim 15, wherein at the step 203, cutting the ends of the leads that protrude from the top surface of the magnetic core into triangles, performing a secondary mold-pressing to bend the triangular ends into the concaves in the top surface of the magnetic core to form the electrodes of the inductor.

17: The method as claimed in claim 7, wherein at the step 204, the product after secondary pressing is subjected to high-temperature annealing treatment in a high-temperature furnace, an annealing temperature is 300 to 900° C., an annealing time is 30 to 120 minutes, and annealing is carried out in nitrogen.

18: The method as claimed in claim 7, wherein at the step 206, removing the insulating film on the terminals to expose the terminals, performing metallization treatment along opposite edges of the lead surface and covering the terminals to form two spaced and expanded terminals extend to both sides of the lead surface of the magnetic core.
